(19) United States
(12) Patent Application Publication
(10) Pub. No.: US 2023/0206256 A1
(43) Pub. Date: Jun. 29, 2023

(54) METHODS, SYSTEMS, APPARATUS, AND ARTICLES OF MANUFACTURE TO MODIFY AUDIENCE ESTIMATES TO PRESERVE LOGICAL CONSISTENCY

(71) Applicant: The Nielsen Company (US), LLC, New York, NY (US)

(72) Inventors: Michael R. Sheppard, Holland, MI (US); DongBo Cui, New York, NY (US); Edward Murphy, Uncasville, CT (US); David Forteguerre, Brooklyn, NY (US); Jessica Lynn White, Plant City, FL (US)

(21) Appl. No.: 17/976,694

(22) Filed: Oct. 28, 2022

Related U.S. Application Data
(60) Provisional application No. 63/294,772, filed on Dec. 29, 2021.

(51) Int. Cl. G06Q 30/02; G06F 16/23

(52) U.S. Cl. CPC G06Q 30/0201; G06F 16/2365

(57) ABSTRACT

Disclosed examples determine constraints based on a structure of initial audience totals; for a number of iterations: select values for modified audience totals that satisfy the constraints, the modified audience totals corresponding respectively to the initial audience totals; and determine an output based on the values for the modified audience totals and the initial audience totals; select final values of the modified audience totals resulting from completion of the number of iterations, the final values of the modified audience totals to be logically consistent; and generate a report including the final values of the modified audience totals.

### RELATED APPLICATION

This patent claims the benefit of U.S. Provisional Patent Application No. 63/294,772, which was filed on Dec. 29, 2021. U.S. Provisional Patent Application No. 63/294,772 is hereby incorporated herein by reference in its entirety. Priority to U.S. Provisional Patent Application No. 63/294,772 is hereby claimed.

### FIELD OF THE DISCLOSURE

This disclosure relates generally to audience measurement and, more particularly, to methods, systems, apparatus, and articles of manufacture to modify audience estimates to preserve logical consistency.

### BACKGROUND

Audience measurement entities (AMEs) collect audience measurement information from panelists (e.g., individuals who agree to be monitored by the AMEs) including the number of deduplicated audience members for particular media and the number of impressions of the media corresponding to each of the audience members. In some examples, different mechanisms, procedures, panels, and/or statistical techniques may be used to collect audience measurement information. For examples, different mechanisms, procedures, panels, and/or statistical techniques may be used to collect audience measurement information on different platforms (e.g., web, television, etc.).

### BRIEF DESCRIPTION OF THE DRAWINGS

FIG. 1 illustrates example client devices that report audience impression requests for Internet-based media to impression collection entities to facilitate estimating sizes of audiences exposed to different Internet-based media and/or different unions of Internet-based media.

FIG. 2 is a block diagram of example audience measurement entity circuitry to modify audience estimates to preserve logical consistency in accordance with teachings of this disclosure.

FIG. 3 is a flowchart representative of example machine readable instructions and/or example operations that may be executed by example processor circuitry to implement the example audience measurement entity circuitry of FIG. 2 to modify audience estimates to preserve logical consistency.

FIG. 4 is a block diagram of an example processing platform including processor circuitry structured to execute the example machine readable instructions and/or the example operations of FIG. 3 to implement the example audience measurement entity circuitry of FIG. 2.

FIG. 5 is a block diagram of an example implementation of the processor circuitry of FIG. 4.

FIG. 6 is a block diagram of another example implementation of the processor circuitry of FIG. 4.

FIG. 7 is a block diagram of an example software distribution platform (e.g., one or more servers) to distribute software (e.g., software corresponding to the example machine readable instructions of FIG. 3) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Techniques for monitoring user access to an Internet-accessible media, such as advertisements and/or content, via digital television, desktop computers, mobile devices, etc. have evolved significantly over the years. Internet-accessible media is also known as digital media. In the past, such monitoring was done primarily through server logs. In particular, entities serving media on the Internet would log the number of requests received for their media at their servers. Basing Internet usage research on server logs is problematic for several reasons. For example, server logs can be tampered with either directly or via zombie programs, which repeatedly request media from the server to increase the server log counts. Also, media is sometimes retrieved once, cached locally and then repeatedly accessed from the local cache without involving the server. Server logs cannot track such repeat views of cached media. Thus, server logs are susceptible to both over-counting and under-counting errors.

The inventions disclosed in Blumenau, U.S. Pat. No. 6,108,637, which is hereby incorporated herein by reference in its entirety, fundamentally changed the way Internet monitoring is performed and overcame the limitations of the server-side log monitoring techniques described above. For example, Blumenau disclosed a technique wherein Internet media to be tracked is tagged with monitoring instructions. In particular, monitoring instructions are associated with the hypertext markup language (HTML) of the media to be tracked. When a client requests the media, both the media and the monitoring instructions are downloaded to the client. The monitoring instructions are, thus, executed whenever the media is accessed, be it from a server or from a cache.

Monitoring instructions cause monitoring data reflecting information about an access to the media (e.g., a media impression) to be sent from the client that downloaded the media to a monitoring entity in association with user identifying and/or device identifying information (e.g., a cookie). Sending the monitoring data from the client to the monitoring entity is known as an impression request (e.g., a hypertext transfer protocol (HTTP) request representing a media impression). Typically, the monitoring entity is an audience measurement entity (AME) that did not provide the media to the client and who is a trusted (e.g., neutral) third party for providing accurate usage statistics (e.g., The Nielsen Company, LLC).

There are many database proprietors operating on the Internet. These database proprietors provide services to large numbers of subscribers. In exchange for the provision of services, the subscribers register with the database proprietors. Examples of such database proprietors include social network sites (e.g., Facebook, Twitter, My Space, etc.), multi-service sites (e.g., Yahoo!, Google, Axiom, Catalina, etc.), online retailer sites (e.g., Amazon.com, Buy.com, etc.), credit reporting sites (e.g., Experian), streaming media sites (e.g., YouTube, Hulu, etc.), etc. These database proprietors set cookies and/or other device/user identifiers on the client devices of their subscribers to enable the database proprietor to recognize their subscribers when they visit their web site.

The protocols of the Internet make cookies inaccessible outside of the domain (e.g., Internet domain, domain name, etc.) on which they were set. Thus, a cookie set in, for example, the facebook.com domain is accessible to servers in the facebook.com domain, but not to servers outside that domain. Therefore, although an AME might find it advantageous to access the cookies set by the database proprietors, they are unable to do so.

The inventions disclosed in Mazumdar et al., U.S. Pat. No. 8,370,489, which is incorporated by reference herein in its entirety, enable an AME to leverage the existing databases of database proprietors to collect more extensive Internet usage by extending the impression request process to encompass partnered database proprietors and by using such partners as interim data collectors. The inventions disclosed in Mazumdar et al. accomplish this task by structuring the AME to respond to impression requests from clients (who may not be a member of an audience member panel and, thus, may be unknown to the audience member entity) by redirecting the clients from the AME to a database proprietor, such as a social network site partnered with the audience member entity, using an impression response. Such a redirection initiates a communication session between the client accessing the tagged media and the database proprietor. For example, the impression response received from the AME may cause the client to send a second impression request to the database proprietor. In response to receiving this impression request, the database proprietor (e.g., Facebook) can access any cookie it has set on the client to thereby identify the client based on the internal records of the database proprietor. In the event the client corresponds to a subscriber of the database proprietor, the database proprietor logs/records a database proprietor demographic impression in association with the client/user.

As used herein, an impression is defined to be an event in which a home or individual accesses media (e.g., an advertisement, content, a group of advertisements and/or a collection of content). In Internet media delivery, a quantity of impressions or impression count is the total number of times media (e.g., content, an advertisement, or advertisement campaign) has been accessed by a web population (e.g., the number of times the media is accessed). In some examples, an impression or media impression is logged by an impression collection entity (e.g., an AME or a database proprietor) in response to an impression request from a user/client device that requested the media. For example, an impression request is a message or communication (e.g., an HTTP request) sent by a client device to an impression collection server to report the occurrence of a media impression at the client device. In some examples, a media impression is not associated with demographics. In non-Internet media delivery, such as television (TV) media, a television or a device attached to the television (e.g., a set-top-box or other media monitoring device) may monitor media being output by the television. The monitoring generates a log of impressions associated with the media displayed on the television. The television and/or connected device may transmit impression logs to the impression collection entity to log the media impressions.

A user of a computing device (e.g., a mobile device, a tablet, a laptop, etc.) and/or television may be exposed to the same media via multiple devices (e.g., two or more of a mobile device, a tablet, a laptop, etc.) and/or via multiple media types (e.g., digital media available online, digital TV (DTV) media temporarily available online after broadcast, TV media, etc.). For example, a user may start watching the Walking Dead television program on a television as part of TV media, pause the program, and continue to watch the program on a tablet as part of DTV media. In such an example, the exposure to the program may be logged by an AME twice, once for an impression log associated with the television exposure, and once for the impression request generated by a census measurement science (CMS) tag executed on the tablet. Multiple logged impressions associated with the same program and/or same user are defined as duplicate impressions. Duplicate impressions are problematic in determining total reach estimates because one exposure via two or more cross-platform devices may be counted as two or more unique audience members. As used herein, reach is a measure indicative of the demographic coverage achieved by media (e.g., demographic group(s) and/or demographic population(s) exposed to the media). For example, media reaching a broader demographic base will have a larger reach than media that reached a more limited demographic base. The reach metric may be measured by tracking impressions for known users (e.g., panelists or non-panelists) for which an audience measurement entity stores demographic information or can obtain demographic information. Deduplication is a process that is used to adjust cross-platform media exposure totals so that a single audience member is not counted multiple times for multiple exposures to the same media delivered/accessed via different media-delivery platforms.

As used herein, a unique audience (e.g., a unique audience size, deduplicated audience size, or audience size) is based on audience members distinguishable from one another. That is, a particular audience member exposed to particular media is measured as a single unique audience member regardless of how many times that audience member is exposed to that particular media. If that particular audience member is exposed multiple times to the same media, the multiple exposures for the particular audience member to the same media is counted as only a single unique audience member. In this manner, impression performance for particular media is not disproportionately represented when a small subset of one or more audience members is exposed to the same media an excessively large number of times while a larger number of audience members is exposed fewer times or not at all to that same media. By tracking exposures to unique audience members, a unique audience measure may be used to determine a reach measure to identify how many unique audience members are reached by media. In some examples, increasing unique audience and, thus, reach, is useful for advertisers wishing to reach a larger audience base.

An AME may want to find unique audience/deduplicate impressions across multiple database proprietors (DPs), custom date ranges, custom combinations of assets and platforms, etc. Some deduplication techniques used by an AME perform deduplication across DPs using additional systems (e.g., Audience Link, etc.). For example, such deduplication techniques match or probabilistically link personally identifiable information (PII) from each source. Such deduplication techniques require storing or exporting massive amounts of user data, using approximations instead of direct measurement or calculating audience overlap for all possible combinations, neither of which are desirable. PII data can be used to represent and/or access audience demographics (e.g., geographic locations, ages, genders, etc.)

Estimating unique audience sizes that are consistent across multiple combinations of platform usage can be a problem in various industries. Platforms include websites, television, streaming media, store visits, advertisements, mobile devices, etc. In some examples, AMEs seek to determine the number of unique people that requested multiple goods and/or services. For example, an AME seeks to determine the number of people that visited multiple websites, the number of viewers of different television shows, or the like. AMEs may be concerned with any area in which unique membership across multiple activities is requested (e.g., by a client of the AME). As such, the unique audience size need not be physical. For example, the unique audience size can correspond to set cardinality (e.g., the number of elements of a set) across different databases.

In examples disclosed herein, website usage and television audience size are considered. For example, audience size may be estimated by different models, samples, and/or other technical or statistical procedures across different platforms (e.g., web, television, etc.). However, examples disclosed herein may be used in conjunction with audience sizes for any type of exposure (e.g., radio exposure, streaming media exposure, movie exposure, store visits, advertisement exposure, etc.). In some examples, while any individual estimate may be valid, the collection of a set of estimates may yield logical inconsistencies.

For example, consider estimating audience size for the number of people who visit three websites {a, b, c} with the goal of estimating the total deduplicated (e.g., unique) audience across all three websites. Depending on what is available to estimating circuitry, different procedures or datasets may be used. For example, a first dataset yields 100 people who visited website a and a second dataset yields 200 people who visited website b. In such an example, an estimate of the deduplicated audience of websites b or c can be determined from a third dataset, which yields 170 people. Individually, each estimate may be valid, but taken together there is a logical inconsistency. For example, it is impossible for 200 people to visit website b but for only 170 people to visit websites b or c, or vice versa. At least one of the numbers are incorrect, if not both.

Frechet inequalities can be implemented as logic circuitry to determine if a collection of estimates across different unions is logically correct. The inequalities can be viewed as rules about how to bound calculations involving probabilities without assuming independence or without making any dependence assumptions. For example, for n sets where Aᵢ is the proportion of the population in set i={1, . . . , n}, the Frechet inequalities are represented in equation 1a and equation 1b below.

$$max ( 0 , S - ( n - 1 ) ) \leq Pr ( {{⋂}_{i = 1}}^{n} {A}_{i} ) \leq {min}_{i} P r ( {A}_{i} ) \qquad Equation la$$

$${max}_{i} Pr ( {A}_{i} ) \leq Pr ( {{⋃}_{i = 1}}^{n} {A}_{i} ) \leq min ( 1 , S ) \qquad Equation 1 b$$

In the example of equation 1 a, the term ∩ represents the intersection of different sets. In the example of equation 1b, the term ∪ represents the union across different sets. In equation 1a and equation 1b, S is equal to the sum of the probabilities of the proportion of the population in set i (e.g., S=Σᵢ₌₁ⁿPr (Aᵢ)). In the equation 1a max represents maximum, min represents minimum, and Pr represents the probability of an event occurring.

In a special case, for a pair of sets including set A and set B, equation 1a and equation 1b can be represented as equation 2a and equation 2b, respectively.

max(0,Pr(A)+Pr(B)−1)≤Pr(A∩B)≤min(Pr(A),Pr(B)) Equation 2a

max(Pr(A),Pr(B))≤Pr(A U B)≤min(1,Pr(A)+Pr(B)) Equation 2b

The example of equation 2a states that the probability of an individual being in the intersection between two sets cannot be more than the minimum probability of being in one the two sets, and if the sum of the respective probabilities of being in the respective sets exceeds 100%, the probability of the individual being in the intersection of the sets exists and cannot be less than that excess. Additionally, the example of equation 2b states that the probability of an individual being in the union between two sets cannot be smaller than the maximum probability of being in both of them, and if the sum of the respective probabilities of being in the respective sets exceeds 100% the probability of the individual being in the union of the sets cannot be more than 100%. Equation 1a and equation 1b are more general formulas for any number of sets. A more general formulation of bounds, for any Boolean operation, was developed by Hailperin in 1965. Examples disclosed herein include use of the more general bounds. For example, equation 3a and equation 3b illustrate a cardinality version of the Frechet inequalities (e.g., equations 1a and 1b).

$$max ( 0 , S - U ( n - 1 ) ) \leq \vert {{⋂}_{i = 1}}^{n} {A}_{i} \vert \leq {min}_{i} \vert {A}_{i} \vert \qquad Equation 3 a$$

$${max}_{i} \vert {A}_{i} \vert \leq \vert {{⋃}_{i = 1}}^{n} {A}_{i} \vert \leq min ( U , S ) \qquad Equation 3 b$$

In equation 3a and equation 3b, for U people in a total population, S is equal to the sum of the absolute values of the proportions of the population in each set i from 1 to n (e.g., S=Σᵢ₌₁^{b}|Aᵢ|). Equation 3a and equation 3b allow for processing of raw numbers without normalization by population. Both (A) equations 1a and 1b and (B) equations 3a and 3b are mathematically equivalent but working with raw numbers is more understandable to humans. In equations 1a, 1b, 2a, 2b, 3a, and 3b, the inequalities are for each type of union or intersection. For example, the inequalities need not include unions of the bottom level margins. However, if the inequalities include higher unions (e.g., unions of unions), then the sets correspond to the higher unions.

As described above, the Frechet inequalities can be utilized to determine if a collection of estimates across different unions is logically correct. For example, consider table 1 which illustrates an example structure of estimated audience values (e.g., deduplicated and/or unique audience totals) across 10 platforms and/or margins (represented as indices, such as (1), (2), etc.) and different unions (represented as indices, such as (11), (12), etc., where (n) represents an indices of a dataset (a margin or union)) in a tree structure association (e.g., where each union corresponds to one or more other unions and/or margins). A union corresponds to a deduplicated audience total for a combination of two or more margins. For example, a first margin may correspond to a number of unique audience members of a first website, a second margin may correspond to a number of unique audience members of a second website and a union may correspond to a number of unique audience members of the first and second websites. Additionally or alternatively, a margin may correspond to a portion of time (e.g., 15 minute increments of a movie or television show), episodes of channel or show, store visits, and/or any other exposure to media.

TABLE 1

| | | | |
|---|---|---|---|
| (1) 43 | (11) 150 | (15) 310 | (16) 500 |
| (2) 45 | | | |
| (3) 98 | | | |
| (4) 64 | | | |
| (5) 34 | (12) 30 | | |
| (6) 9 | | | |
| (7) 64 | (13) 110 | | |
| (8) 44 | | | |
| (9) 79 | (14) 130 | → | |
| (10) 55 | | | |

In the example of table 1, the number in parentheses is an index of the associated value. For example, index (1) indicates that the audience size of a first platform individually was 43 people. Additionally, index (13) indicates that the union of the unique (e.g., deduplicated) audience sizes of a seventh and eight platform is 110 people. The arrow in the bottom row of table 1 represents that index (16) is the unique (e.g., deduplicated) union of index (15) and index (14). Although table 1 illustrates a particular structure of audience data for margins and/or unions, the audience data may be in any structure. For example, a simple structure may initial audience totals of different episodes (e.g., margins) of a television show with total initial audience total per season (e.g., each season corresponding to a union of episode margins), and an initial audience total for the series (e.g., a union of all the season unions).

The example of table 1 may appear to be logically consistent. However, considering the Frechet inequalities, table 1 is actually logically inconsistent. Assuming that listed values in table 1, and that the total population size (U) is much larger compared to any of the estimated audience sizes (e.g., such that U would not impact any union bound after taking the minimum) the following values are logically consistent.

For example, index (12) is listed as 30 people, but the lower bound is 34 (e.g., max (34, 9) per equation 3b above). Thus, the union of indices (5) and (6) (e.g., index (12)) is logically inconsistent because you cannot have a smaller audience total for a union than the largest margin included in that union. For example, if the total number of people exposed to a website corresponding to index (5) is 34, then the total audience size of any union including index (5) has to be higher than 34. Additionally, for example, index (13) is listed as 110 people, but the upper bound is 108 (e.g., min (U, 64+44) per equation 3b above). Thus, the union of indices (7) and (8) (e.g., index (13)) is logically inconsistent because an audience total of a union cannot be larger than the sum of the corresponding margins. Also, for example, index (15) is listed as 310 people, but the upper bound is 290 (e.g., min (U, 150+30+110) per equation 3b above). Thus, the union of indices (11), (12), and (13) (e.g., index (15)) is logically inconsistent. The index (16) is also logically inconsistent. For example, index (16) is listed as 500 people, but the upper bound is 440 (e.g., min (U, 310+130) per equation 3b above). Thus, the union of indices (14) and (15) (e.g., index (16)) is logically inconsistent.

The above logical inconsistencies may be a result of the techniques utilized to determine the audience sizes. Accordingly, the initial audience totals and/or impressions counts generated by a server and/or other computing device can be inaccurate. To correct the server and/or computing device-based error and avoid logical inconsistencies due to the techniques to estimate the initial audience sizes and/or impression totals, examples disclosed herein adjust datasets to ensure consistency and more accurate deduplicated audience totals and/or impression information. For example, let Xᵢ be a proposed modified audience size estimate for population Aᵢ. One possible way to modify Aᵢ would be to minimize the absolute different between Xᵢ and Aᵢ (e.g., |Xᵢ−Aᵢ| or the squared counterpart (Xᵢ−Aᵢ)²). However, minimizing the absolute difference between Xᵢ and Aᵢ may lead to unusual behavior for larger audience size estimates.

To avoid the unusual behaviors for larger audience size estimates, examples disclosed herein can minimize relative change between X and Aᵢ (e.g.,

$$\frac{\vert {X}_{i} - {A}_{i} \vert}{{A}_{i}} ,$$

a ratio of (a) the absolute difference between a modified deduplicated audience total of an index and the obtained initial audience total of the index and (b) the obtained initial audience total of the index). The squared counterpart of examples disclosed herein is least squares or a squared relative change (e.g.,

$${( \frac{{X}_{i}}{{A}_{i}} - 1 )}^{2} ,$$

the difference of (a) a ratio of the modified deduplicated audience total of an index and the obtained initial audience total of the index and (b) one, squared).

Disclosed modifications may be improved (e.g., optimized) according to equation 4 below.

$$minimize {\sum }_{i ∈ Ω} {( \frac{{X}_{i}}{{A}_{i}} - 1 )}^{2} \qquad Equation 4$$

The example of equation 4 is subject to an inequality constraint (e.g., AX≤B) and an equality constraint (e.g., CX=D). In the example inequality constraint, A and B are vectors of values that are related to the inequality that is being utilized (e.g., equation 3a or equation 3b). In the example equality constraint, C and D are vectors of values that may be particular to the implementation. For example, for some websites, a priori knowledge may indicate that the websites should have the same audience size. In additional or alternative examples, a priori knowledge may indicate that a first audience estimate is much more accurate than a second audience estimate and the equality constraint can force the second audience estimate to equal the first audience estimate. In some examples, processor circuitry implementing equation 4 minimizes outside of the originally collected data by requiring the Xᵢ values to equal the a priori knowledge. In some examples,

$$( \frac{{X}_{i}}{{A}_{i}} - 1 )$$

in Equation 4 can be replaced with

$$\frac{\vert {X}_{i} - {A}_{i} \vert}{{A}_{i}} .$$

In the example of equation 4, the term Ω represents the set of audiences that are to be updated, but it need not include all audiences being processed (e.g., Ω can include indices (1)-(7) but not indices (8)-(10) of Table 1). The indices that are to be processed and are not to be processed may be based on the techniques used to obtain the values corresponding to the indices, user preferences, etc. However, even if not all audiences being processed are to be modified, the audiences being processed should satisfy the Frechet inequalities. As an example, if all values within table 1 are eligible to be updated, an inequality for index (13) is represented in equation 5 below.

max{X₇,X₈}≤X₁₃≤min(U,X₇+X₈) Equation 5

Example equation 5 can be rewritten into the form AX≤B, as shown in equation 6a, equation 6b, equation 6c, and equation 6d.

X₇−X₁₃≤0 Equation 6a

X₈−X₁₃≤0 Equation 6b

X₁₃≤U Equation 6c

−X₇−X₈+X₁₃≤0 Equation 6d

In examples disclosed herein, processor circuitry selects values for Xᵢ that satisfies the constraints (e.g., the above-listed inequalities and/or any other constraints that relate to the structure of the obtained data) and evaluates Equation 4 for each Xᵢ value. In some examples, each Xᵢ value can be programmed readily as a constant matrix A. After one interaction is complete, examples disclosed herein adjust Xᵢ value(s) that satisfy the constraints and reevaluate Equation 4 based on the adjusted Xᵢ value(s) for a second iteration. Examples disclosed herein interactively update and evaluate based on adjusted Xᵢ values until a minimum summation is found (e.g., the amount of change between one iteration and another iteration is less than a threshold amount). The example of table 2 illustrates an output of the full minimization across all audiences of table 1 using examples disclosed herein. Table 2 includes corrected values shown to two decimals. Table 2 does not include logical inconsistencies in view of the Frechet inequalities.

TABLE 2

| | | | |
|---|---|---|---|
| (1) 43 | (11) 158.19 | (15) 300.25 | (16) 434.40 |
| (2) 45 | | | |
| (3) 98 | | | |
| (4) 64 | | | |
| (5) 31.94 | (12) 31.94 | | |
| (6) 9 | | | |
| (7) 65.45 | (13) 110.13 | | |
| (8) 44.68 | | | |
| (9) 79.10 | (14) 134.15 | → | |
| (10) 55.05 | | | |

In example operation, processor circuitry implementing examples disclosed herein accesses a dataset (e.g., table 1) stored in a database. The processor circuitry selects values of the dataset to be modified. For example, processor circuitry selects audience sizes for the websites and other related values in the dataset (e.g., higher up in the hierarchy). The processor circuitry rearranges the selected values according to equations 6a, 6b, 6c, and 6d. The processor circuitry then forms the A, B, C, and D matrices and then executes equation 4 to determine the X matrix. For example, the processor circuitry minimizes the X matrix.

In some examples, other constraints can be applied to equation 4 in addition to or as an alternative to the inequality constraint and/or the equality constraint (e.g., practical considerations can be utilized when implementing constraints). For example, in an example where Xᵢ is expected to be outside any Frechet inequality requirements, Xᵢ can be bounded between two values close to Aᵢ (e.g., +/−5% maximum relative change due to business considerations would be (0.95 Aᵢ)≤Xᵢ≤(1.05 Aᵢ).

As described above, in some examples, the Frechet inequalities can be represented more generally for any Boolean operation. Many use cases encountered in the advertising industry are set unions or intersections but the need not be the case. As such, in some examples, the more general representations (e.g., Hailperin representations) may be used. In the Hailperin notation, Aᵢ represents a set and a, represents a numerical value of the set. For example, if a priori knowledge of the audience size of {A₁, A₂, A₃} is available, equation 7 represents upper and lower bounds for two of the three sets. The best upper bound (BUB) is illustrated in equation 8.

$$ϕ ( {A}_{1} , {A}_{2} , {A}_{3} ) = {A}_{1} {A}_{2} {A}_{3}^{′} ⋁ {A}_{1} {A}_{2}^{′} {A}_{3} ⋁ {A}_{1}^{′} {A}_{2} {A}_{3} \qquad Equation 7$$

$${BUB}_{ϕ} = min ( \frac{{a}_{1} + {a}_{2} + {a}_{3}}{2} , {a}_{1} + {a}_{2} , {a}_{1} + {a}_{3} , {a}_{2} + {a}_{3} , \overline{{a}_{1}} + \overline{{a}_{2}} + \overline{{a}_{3}} ) \qquad Equation 8$$

In equation 8, ā_{ι}=1−aᵢ. If the BUB_{ϕ} is the best upper bound of P(ϕ), then 1−BUB_{ϕ} is the best lower bound of 1−P(ϕ)=P(ϕ′). Examples disclosed herein utilize the arithmetic fact that 1−min (a, b, c, . . . )=max (1−a, 1−b, 1−c, . . . ). For a numerical estimate of the value of (e.g., equation 7) and variable values for each of {a₁, a₂, a₃}, equation 8 is equivalent to equations 9a, 9b, 9c, 9d, and 9e in the form of AX≤B. A similar set of inequalities can be constructed for the lower bound of ϕ.

$$- ( \frac{1}{2} ) {a}_{1} - ( \frac{1}{2} ) {a}_{2} - ( \frac{1}{2} ) {a}_{3} + ϕ \leq 0 \qquad Equation 9 a$$

$$- {a}_{1} - {a}_{2} + ϕ \leq 0 \qquad Equation 9 b$$

$$- {a}_{1} - {a}_{3} + ϕ \leq 0 \qquad Equation 9 c$$

$$- {a}_{2} - {a}_{3} + ϕ \leq 0 \qquad Equation 9 d$$

$${a}_{1} + {a}_{2} + {a}_{3} + ϕ \leq 0 \qquad Equation 9 e$$

Examples disclosed herein can also be generalized to incorporate impressions. For example, examples disclosed herein can minimize the sum of relative changes. For a known value of impressions, Rᵢ, to be updated to a value Tᵢ, equation 10 may be implemented to modify audience size values and incorporate impressions.

$$minimize {\sum }_{i ∈ Ω} {( \frac{{X}_{i}}{{A}_{i}} - 1 )}^{2} + {\sum }_{i ∈ Ω} {( \frac{{T}_{i}}{{R}_{i}} - 1 )}^{2} \qquad Equation 10$$

The example of equation 10 is subject to an inequality constraint (e.g., AM≤B) and an equality constraint (e.g., CM=D). In the example of equation 10, the vector M is an appended version of the previous vector X as there is now a constraint applied to impressions and audience size that are considered together. Indices of equation 10 are subject to the following inequality depending on which variable of either side of the inequality is to be updated: {Tᵢ, Rᵢ}≥{Xᵢ, Aᵢ}. Additionally, the restriction of audience deduplication of (e.g., equation 3) does not apply to impressions. Generally, the number of impressions of a union of sets is equal to the sum of impressions of the sets being combined via the union. Additionally, the set of audience sizes that may be under consideration to be updated may be different than the set of impressions.

Bounds on frequency updates can also be utilized. For example, assuming that for an index i both impressions and audience size can be updated but it is preferred that the originally observed frequency, fᵢ, not differ substantially, equation 11 may implemented by processor circuitry. Equation 11 can be rearranged in standard notation as illustrated in equations 12a and 12b. Additional or alternative inequalities and/or restrictions can be applied.

$$( 1 - a ) {f}_{i} \leq \frac{{T}_{i}}{{X}_{i}} \leq ( 1 + a ) {f}_{i} \qquad Equation 11$$

$$( 1 - a ) {f}_{i} {X}_{i} - {T}_{i} \leq 0 \qquad Equation 12 a$$

$$- ( 1 + a ) {f}_{i} {X}_{i} + {T}_{i} \leq 0 \qquad Equation 12 b$$

Examples disclosed herein make each level and aggregation of table 1 logically consistent by implementing relative changes to values. If absolute change were made in a minimization, then the change would start from the smaller audience sizes and increase as changing the larger audiences would make an objective function be initially large. While that may be useful in some applications, the choice of objective function is a choice of the user dependent on practical considerations. For example, in some industries, the square of the relative change (e.g., equation 4) can be used as an example as it incorporates all indices of a set at the same level.

Examples disclosed herein need not be limited to audience size and/or impressions. For example, if there is a third tier of interest (e.g., duration impressions), examples disclosed herein may also include such third tier. Further, any number of tiers are possible, as long as the associated logical constraints are also incorporated. Accordingly, examples disclosed herein allow for testing of logical consistency, and if such testing fails, modification values in a minimal sense to maintain consistency throughout a dataset.

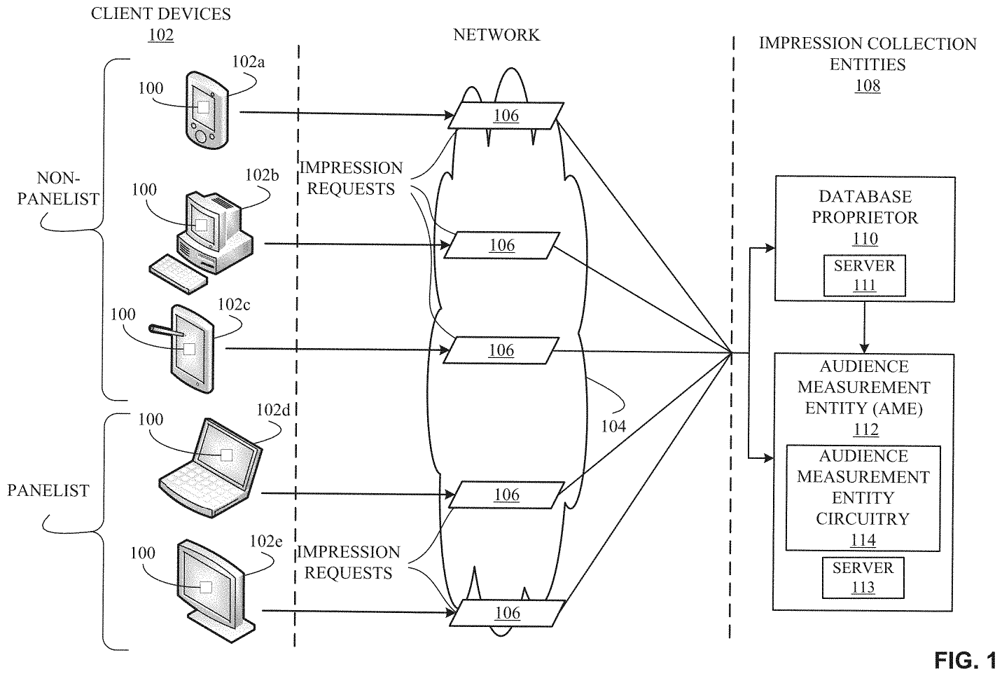

FIG. 1 illustrates example client devices 102 that report audience impression requests for Internet-based media 100 to impression collection entities 108 to identify a deduplicated audience and/or a frequency distribution for the Internet-based media. The illustrated example of FIG. 1 includes the example client devices 102, an example network 104, example impression requests 106, and the example impression collection entities 108. As used herein, an impression collection entity 108 refers to any entity that collects impression data such as, for example, an example AME 112 and/or an example database proprietor 110. In the illustrated example, the AME 112 includes an example audience measurement entity circuitry 114.

The example client devices 102 of the illustrated example may be any device capable of accessing media over a network (e.g., the example network 104). For example, the client devices 102 may be an example mobile device 102a, an example computer 102b, 102d, an example tablet 102c, an example smart television 102e, and/or any other Internet-capable device or appliance. Examples disclosed herein may be used to collect impression information for any type of media including content and/or advertisements. Media may include advertising and/or content delivered via websites, streaming video, streaming audio, Internet protocol television (IPTV), movies, television, radio and/or any other vehicle for delivering media. In some examples, media includes user-generated media that is, for example, uploaded to media upload sites, such as YouTube, and subsequently downloaded and/or streamed by one or more other client devices for playback. Media may also include advertisements. Advertisements are typically distributed with content (e.g., programming, on-demand video and/or audio). Traditionally, content is provided at little or no cost to the audience because it is subsidized by advertisers that pay to have their advertisements distributed with the content. As used herein, “media” refers collectively and/or individually to content and/or advertisement(s).

The example network 104 is a communications network. The example network 104 allows the example impression requests 106 from the example client devices 102 to the example impression collection entities 108. The example network 104 may be a local area network, a wide area network, the Internet, a cloud, or any other type of communications network.

The impression requests 106 of the illustrated example include information about accesses to media at the corresponding client devices 102 generating the impression requests. Such impression requests 106 allow monitoring entities, such as the impression collection entities 108, to collect a number of media impressions for different media accessed via the client devices 102. By collecting media impressions, the impression collection entities 108 can generate media impression quantities for different media (e.g., different content and/or advertisement campaigns).

The impression collection entities 108 of the illustrated example include the example database proprietor 110 and the example AME 112. In the illustrated example, the example database proprietor 110 may be one of many database proprietors that operate on the Internet to provide services to subscribers. Such services may be email services, social networking services, news media services, cloud storage services, streaming music services, streaming video services, online retail shopping services, credit monitoring services, etc. Example database proprietors include social network sites (e.g., Facebook, Twitter, MySpace, etc.), multi-service sites (e.g., Yahoo!, Google, Axiom, Catalina, etc.), online retailer sites (e.g., Amazon.com, Buy.com, etc.), credit reporting sites (e.g., Experian), streaming media sites (e.g., YouTube, etc.), and/or any other site that maintains user registration records.

In some examples, execution of the beacon instructions corresponding to the media 100 causes the client devices 102 to send impression requests 106 to servers 111, 113 (e.g., accessible via an Internet protocol (IP) address or uniform resource locator (URL)) of the impression collection entities 108 in the impression requests 106. In some examples, the beacon instructions cause the client devices 102 to provide device and/or user identifiers and media identifiers in the impression requests 106. The device/user identifier may be any identifier used to associate demographic information with a user or users of the client devices 102. Example device/user identifiers include cookies, hardware identifiers (e.g., an international mobile equipment identity (IMEI), a mobile equipment identifier (MEID), a media access control (MAC) address, etc.), an app store identifier (e.g., a Google Android ID, an Apple ID, an Amazon ID, etc.), an open source unique device identifier (OpenUDID), an open device identification number (ODIN), a login identifier (e.g., a username), an email address, user agent data (e.g., application type, operating system, software vendor, software revision, etc.), an Ad ID (e.g., an advertising ID introduced by Apple, Inc. for uniquely identifying mobile devices for purposes of serving advertising to such mobile devices), third-party service identifiers (e.g., advertising service identifiers, device usage analytics service identifiers, demographics collection service identifiers), etc. In some examples, fewer or more device/user identifier(s) may be used. The media identifiers (e.g., embedded identifiers, embedded codes, embedded information, signatures, etc.) enable the impression collection entities 108 can identify to media (e.g., the media 100) objects accessed via the client devices 102. The impression requests 106 of the illustrated example cause the AME 112 and/or the database proprietor 110 to log impressions for the media 100. In the illustrated example, an impression request is a reporting to the AME 112 and/or the database proprietor 110 of an occurrence of the media 100 being presented at the client device 102. The impression requests 106 may be implemented as a hypertext transfer protocol (HTTP) request. However, whereas a transmitted HTTP request identifies a webpage or other resource to be downloaded, the impression requests 106 include audience measurement information (e.g., media identifiers and device/user identifier) as its payload. The server 111, 113 to which the impression requests 106 are directed is programmed to log the audience measurement information of the impression requests 106 as an impression (e.g., a media impression such as advertisement and/or content impressions depending on the nature of the media accessed via the client device 102). In some examples, the server 111, 113 of the database proprietor 101 or the AME 112 may transmit a response based on receiving an impression request 106. However, a response to the impression request 106 is not necessary. It is sufficient for the server 111, 113 to receive/obtain (via one or more wireless communications) the impression request 106 to log an impression request 106. As such, in examples disclosed herein, the impression request 106 is a dummy HTTP request for the purpose of reporting an impressions but to which a receiving server need not respond to the originating client device 102 of the impression request 106. In some examples, when the database proprietor 110 determines deduplicated audience totals for one or more margins (e.g., websites, parts of media, time segments, etc.) and/or one or more unions of the one or more margins, the server 111 may transmit the deduplicated audience totals for the one or more margins and/or one or more unions to the server 113 of the example AME 112.

The example database proprietor 110 maintains user account records corresponding to users registered for services (such as Internet-based services) provided by the database proprietors. That is, in exchange for the provision of services, subscribers register with the database proprietor 110. As part of this registration, the subscribers provide detailed demographic information to the database proprietor 110. Demographic information may include, for example, gender, age, ethnicity, income, home location, education level, occupation, etc. In the illustrated example, the database proprietor 110 sets a device/user identifier on a subscriber's client device 102 that enables the database proprietor 110 to identify the subscriber.

In the illustrated example, the example AME 112 does not provide the media 100 to the client devices 102 and is a trusted (e.g., neutral) third party (e.g., The Nielsen Company, LLC) for providing accurate media access (e.g., exposure) statistics. The example AME 112 includes the example audience measurement entity circuitry 114. As further disclosed herein, the example audience measurement entity circuitry 114 corrects server-based estimation error by modifying deduplicated audience total estimates and/or total impressions counts for one or more margins and/or unions to preserve logical consistency.

In operation, the example client devices 102 employ web browsers and/or applications (e.g., apps) to access media. Some of the web browsers, applications, and/or media include instructions that cause the example client devices 102 to report media monitoring information to one or more of the example impression collection entities 108. That is, when the client device 102 of the illustrated example accesses media, a web browser and/or application of the client device 102 executes instructions in the media, in the web browser, and/or in the application to send the example impression request 106 to one or more of the example impression collection entities 108 via the network (e.g., a local area network, wide area network, wireless network, cellular network, the Internet, and/or any other type of network). The example impression requests 106 of the illustrated example include information about accesses to the media 100 and/or any other media at the corresponding client devices 102 generating the impression requests 106. Such impression requests allow monitoring entities, such as the example impression collection entities 108, to collect media impressions for different media accessed via the example client devices 102. In this manner, the impression collection entities 108 can generate media impression quantities for different media (e.g., different content and/or advertisement campaigns).

When the server 111 of the example database proprietor 110 receives the example impression request 106 from the example client device 102, the example database proprietor 110 requests the client device 102 to provide a device/user identifier that the database proprietor 110 had previously set for the example client device 102. The example database proprietor 110 uses the device/user identifier corresponding to the example client device 102 to identify the subscriber of the client device 102. The server 11 of the example database proprietor 110 transmit logged impression information to the example AME 112. In some examples, the database proprietor 110 determines initial audience total(s) for one or more margins and/or one or more unions of the one or more margins using one or more techniques. In such examples, the server 111 of the database proprietor 110 may transmit the initial audience total(s) to the example AME 112.

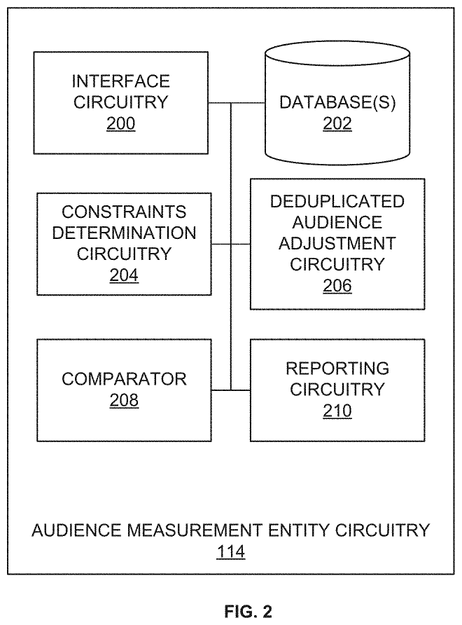

The example server 113 of the AME 112 receives database proprietor demographic impression data and/or initial audience total(s) from the server 111 of the example database proprietor 110. The database proprietor demographic impression data may include information relating to a total number of the logged database proprietor impressions that correspond with a registered user of the database proprietor 110 and/or any other information related to the logged database proprietor impressions (e.g., demographics, a total number of registered users exposed to the media 100 more than once, etc.). The example audience measurement entity circuitry 114 corrects server-based estimation error by modifying initial audience total estimates and/or total impressions counts for one or more margins and/or unions to preserve logical consistency, as further described below in conjunction with FIG. 2.

FIG. 2 illustrates an example block diagram of example audience measurement entity circuitry 114 of FIG. 1. The example audience measurement entity circuitry 114 includes example interface circuitry 200, example database(s) 202, example constraints determination circuitry 204, example deduplication audience adjustment circuitry 206, an example comparator 208, and example reporting circuitry 210. In some examples, the components of the audience measurement entity circuitry 114 are connected via a bus.

The example audience measurement entity circuitry 114 of FIG. 2 is a computing device and/or processing device that is capable of storing datasets (e.g., initial audience total(s), impression total(s), etc.), correcting server-based estimation errors by adjusting the datasets, and generating a report based on the server-based estimation error correction. The audience measurement entity circuitry 114 may be a computer, a server, and/or any other computing device. In some examples the audience measurement entity circuitry 114 more or fewer components than those shown in the example of FIG. 2. For example, the example audience measurement entity circuitry 114 may include a user interface to display results of the server-based estimation error correction and/or obtain user preferences.

The interface circuitry 200 of FIG. 2 may include one or more interfaces to obtain and/or access the data obtained from the example server 113 (e.g., via a bus or other connection). Additionally, the interface circuitry 200 may log impressions obtained via network communications to be stored in the database(s) 202. Additionally, the interface circuitry 200 may transmit and/or store generated reports corresponding to results of the estimation error correction to other devices (e.g., by causing a transmitter, transmission circuitry, and/or the server 113 to transmit the report to another device via a wired or wireless communication).

The example database(s) 202 of FIG. 2 are storage devices (e.g., memory, storage, etc.) that includes one or more datasets. In the example of FIG. 2, the dataset corresponds to media exposure data (e.g., impression data, visitors to one or more websites, number of initial estimates of audience members exposed to media at one or more margins and/or unions, and/or any other media exposure data that relates panelist and/or audience identifiers to media accesses). However, the dataset may correspond to any type of data. As described above, the initial audience estimations and/or total impression information may be inaccurate due to the techniques used to obtain such information. Accordingly, the obtained dataset may be faulty and/or inaccurate, thereby resulting in inconsistent information that is not practically or logically consistent. For example, the initial estimate of a deduplicated audience total of a union of two margins being higher than the sum of the initial audience totals for the two margins is logically inconsistent. Additionally, the example database(s) 202 may store generate reports corresponding to adjusted/modified total audience total(s) and/or impressions totals that have been adjusted to be consistent and more accurate.

The example constraints determination circuitry 204 of FIG. 2 determines the constraints (e.g., Frechet inequality requirements) of a dataset that corresponds to media exposure, store visits, advertisement exposure, etc. For example, the constraints are based on the structure of the margins and/or the unions in the dataset. For example, a deduplicated audience total of a union cannot be larger than the sum of the deduplicated audience totals of margins that make up the union or the total audience across all margins/unions. Additionally, the deduplicated audience total of the union cannot be smaller than the highest deduplicated audience total of the margins that make up the union. An example of constraints is further described above in conjunction with Equations 5 and 6a-6d, Equations 9a-9e, or Equations 11 and 12a-b, depending on the context of the dataset. In some examples, the constraints determination circuitry 204 may determine other constraints. For example, in an example where Xᵢ is expected to be outside any Frechet inequality requirements, Xᵢ can be bounded between two values close to Aᵢ (e.g., +/−5% maximum relative change due to business considerations would be (0.95 Aᵢ)≤Xᵢ≤(1.05 Aᵢ) where the amount of relative change is based on user and/or manufacturer preferences). In the above example, the values selected for Xᵢ cannot be less than five percent lower or five percenter higher than the value of Aᵢ. For example, for a 5% binding, if Ai is 100, Xi must be greater than or equal to 95 and less than or equal to 105.

The example deduplication audience adjustment circuitry 206 performs an iterative process to find values for the deduplicated audience totals that are consistent across the margins and/or unions. For example, the deduplication audience adjustment circuitry 206 may select values for the modified deduplicated audience total estimates Xᵢ that satisfies the constraints. After selected, the deduplication audience adjustment circuitry 206 applies the modified deduplicated audience total estimates Xᵢ, along with the obtained initial audience total estimates Aᵢ, to the least square minimization of Equation of the above equation 4. In some examples, the deduplication audience adjustment circuitry 206 performs a threshold number of iterations (e.g., based on user and/or manufacturer preferences) with different modified deduplicated audience total estimate(s) to generate multiple outputs (e.g., the least squares or squared relative change output of equation

$$4 ( {\sum }_{i ∈ Ω} {( \frac{{X}_{i}}{{A}_{i}} - 1 )}^{2} ) ) .$$

In such examples, the modified deduplicated audience total estimate(s) that results in the lowest output is used for the final modified audience total estimate(s). Additionally or alternatively, the deduplication audience adjustment circuitry 206 continues to adjust the modified deduplicated audience total estimates X until the difference in the sums of the least squares outputs of two subsequent iterations is below a threshold amount. For example, each iteration may result in a slightly lower output, but the difference may not be statistically relevant. Accordingly, the deduplication audience adjustment circuitry 206 can stop performing interactions when the output has minimized enough (e.g., based on user and/or manufacturer preferences). In some examples, the deduplication audience adjustment circuitry 206 evaluates the above equations 7 and 8 (e.g., if a priori information about the audience sizes is available), or equation 10 (e.g., if impressions counts are available), depending on the information available in the dataset.

The example comparator 208 of FIG. 2 compares the outputs (e.g.,

$${\sum }_{i ∈ Ω} {( \frac{{X}_{i}}{{A}_{i}} - 1 )}^{2}$$

of each iteration) of the different iterations to be able to identify the output that is the lowest. In this manner, the deduplication audience adjustment circuitry 206 can select the modified deduplicated audience total estimates Xᵢ that correspond to the smallest output to be the final deduplicated audience total estimates. In some examples, the comparator 208 can compare the output of one iteration to another to determine if the difference between outputs is less than a threshold amount. In this manner, the deduplication audience adjustment circuitry 206 can determine when to stop performing iterations based on the comparison.

The example reporting circuitry 210 of FIG. 2 generates a report that includes the selected modified deduplicated audience total estimates that minimize the output corresponding to the above equation 4, equations 7 and 8, or equation 10. For example, the reporting circuitry 210 can generate a report that corresponds to the information in the above table 2 based on the obtained data that corresponds to the above table 1. In some examples, the reporting circuitry 210 stores the generated report in memory (e.g., the example database(s) 202. In some examples, the reporting circuitry 210 outputs the information corresponding to the report. For example, the reporting circuitry 210 can cause the information corresponding to the report to be output via a user interface or transmitted to another device (e.g., using the interface circuitry 200 and/or the server 113) via a wired or wireless communication.

While an example manner of implementing the audience measurement entity circuitry 114 is illustrated in FIG. 2, one or more of the elements, processes and/or devices illustrated in FIG. 2 may be combined, divided, re-arranged, omitted, eliminated and/or implemented in any other way. Further, the example server 113, the example interface circuitry 200, the example database(s) 202, the example constraints determination circuitry 204, the example deduplicated audience adjustment circuitry 206, the example comparator 208, the example reporting circuitry 210, and/or, more generally, the example audience measurement entity circuitry 114 of FIG. 2 may be implemented by hardware alone or by hardware in combination with software and/or firmware. Thus, for example, any of the example server 113, the example interface circuitry 200, the example database(s) 202, the example constraints determination circuitry 204, the example deduplicated audience adjustment circuitry 206, the example comparator 208, the example reporting circuitry 210, and/or, more generally, the example audience measurement entity circuitry 114 of FIG. 2 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). Further still, the example server 113, and/or the example audience measurement entity circuitry 114 of FIG. 2 may include one or more elements, processes and/or devices in addition to, or instead of, those illustrated in FIG. 2, and/or may include more than one of any or all of the illustrated elements, processes, and devices.

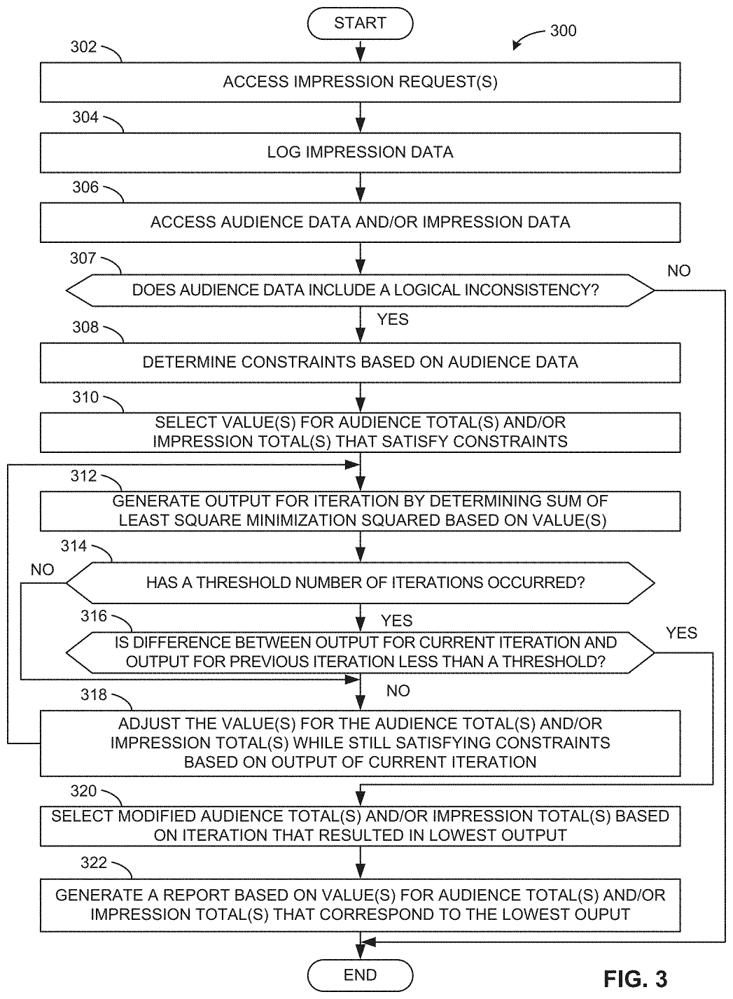

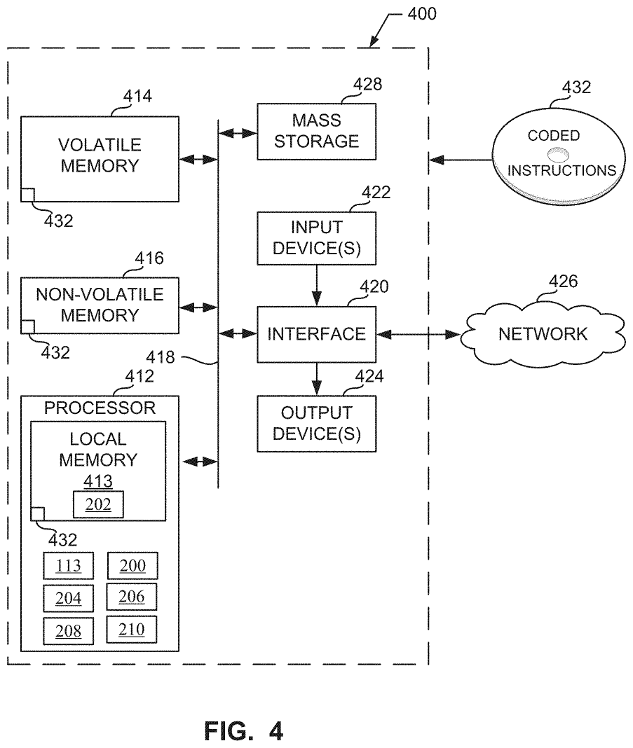

A flowchart representative of example hardware logic, machine readable instructions, hardware implemented state machines, and/or any combination thereof for implementing the server 113 and/or the audience measurement entity circuitry 114 of FIG. 2 is shown in FIG. 3. The machine readable instructions may be one or more executable programs or portion(s) of an executable program for execution by a computer processor and/or processor circuitry, such as the processor 412 shown in the example processor platform 400 discussed below in connection with FIG. 4. The program(s) may be embodied in software stored on a non-transitory computer readable storage medium such as a CD-ROM, a floppy disk, a hard drive, a solid-state driver (SSD), a DVD, a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program(s) is/are described with reference to the flowcharts illustrated in FIG. 3, many other methods of implementing the example audience measurement entity circuitry 114 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example process of FIG. 4 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 3 illustrates an example flowchart representative of example machine readable instructions 300 that may be executed by the audience measurement entity circuitry 114 of FIG. 2 to correct server-based errors in data estimation by modifying the dataset preserve logical consistency. Although the flowchart of FIG. 3 is described in conjunction with deduplicated audience totals and the example audience measurement entity circuitry 114 of FIG. 2, the instructions may be executed by any computer device with any type of data (e.g., impressions totals, store visits, media exposure, etc.).

At block 302, the example server 113 (FIG. 1) accesses, obtains, and/or receives initial audience totals and impression request(s) totals across one or more margins and/or unions from the database proprietor 110 and/or the example client device 102 (FIG. 1) via network communications (e.g., corresponding to the network 104 of FIG. 1). In some examples, the server 113 obtains information corresponding to the impression request(s) 106 from the example database proprietor 110 (FIG. 1), as further described above in conjunction with FIG. 1. As described above, the impression requests 106 include information related an access of media (e.g., an advertisement, a show, a podcast, a video, audio, an image, etc.) by one or more of client devices 102. As described above, the obtained initial estimations for deduplicated audience total(s) and/or impression total(s) may be inaccurate based on the technique used to estimate such data, which leads to logical inconsistencies. Accordingly, the example audience measurement entity circuitry 114 iteratively processes the inaccurate and logically inconsistent data created by the server 111 to ensure logically consistent and more accurate data. The example interface circuitry 200 stores the obtained initial audience total(s) and/or impression total(s) in the example database(s) 202.

At block 304, the example server 113 logs the impression data in the example database(s) 202. In examples in which just initial audience totals are obtained, block 304 may be eliminated. At block 306, the example constraints determination circuitry 204 accesses the audience data (e.g., the estimated initial audience total(s) across one or more margins and one or more unions) and/or impression data (e.g., the estimate impression total(s) across one or more margins and one or more unions) from the example database(s) 202. At block 307, the example deduplicated audience adjustment circuitry 206 determines if the audience data and/or impression data includes a logical inconsistency (e.g., one of the initial audience totals and/or impression counts does not satisfy one or more constraints). If the example deduplication audience adjustment circuitry 206 determines that the audience data and/or impression data does not include a logical inconsistency (block 307: NO), the process ends.

If the example deduplication audience adjustment circuitry 206 determines that the audience data and/or impression data includes a logical inconsistency (block 307: YES), the example constraints determination circuitry 204 determines the constraints based on the structure of the audience data (e.g., how the margins and/or unions are structured in the audience data) (block 308). For example, for unions in the audience data, the deduplicated audience total of a union cannot be larger than the sum of the deduplicated audience totals of margins that make up the union or the total audience across all margins/unions. Additionally, the deduplicated audience total of the union cannot be smaller than the highest deduplicated audience total of the margins that make up the union. An example of constraints is further described above in conjunction with Equations 5 and 6a-6d, Equations 9a-9e, or Equations 11 and 12a-b, depending on the context of the dataset. In some examples, the constraints determination circuitry 204 may determine other constraints. For example, in an example where Xᵢ is expected to be outside any Frechet inequality requirements, Xᵢ can be bounded between two values close to Aᵢ (e.g., +/−5% maximum relative change due to business considerations would be (0.95 Aᵢ)≤Xᵢ≤(1.05 Aᵢ) where the amount of relative change is based on user and/or manufacturer preferences). In the above example, the values selected for Xᵢ cannot be less than five percent lower or five percenter higher than the value of Aᵢ. For example, for a 5% binding, if Ai is 100, Xi must be greater than or equal to 95 and less than or equal to 105. According to the Frechet inequality, Xᵢ must be within a threshold range of Aᵢ. In some examples, the constraints determination circuitry 204 may determine constraints based on impressions total and/or a priori information, as further described above.

At block 310, the example deduplicated audience adjustment circuitry 206 selects value(s) for the modified audience total(s) (Xi) and/or modified impressions total(s) (Ti) that satisfy the constraints. For example, if a particular value for an obtained audience total satisfies the constraints, the deduplicated audience adjustment circuitry 206 will select the corresponding modified audience total to be the same as the obtained audience total. However, if the particular value for the obtained audience total does not satisfy the constraints, the deduplicated audience adjustment circuitry 206 will select a value that is close to the audience total and satisfies the constraints. In some examples, one or more of the obtained audience totals and/or impression totals may not be adjusted (e.g., based on user and/or manufacturer preferences). For example, if one or more of the obtained initial audience totals and/or impressions totals were estimated by a technique that is robust (e.g., the estimates are determined with more than a threshold amount of confidence), then those audience totals will be set and not adjusted. In some examples, the deduplicated audience adjustment circuitry 206 selects value(s) based on results of previous iterations (e.g., to attempt to ensure that the next iteration will result in a lower output).

At block 312, the deduplicated audience adjustment circuitry 206 generates an output (e.g., the sum of squares

$$( {\sum }_{i ∈ Ω} {( \frac{{X}_{i}}{{A}_{i}} - 1 )}^{2} )$$

for the current iteration by determining the sum of squares based on the selected value(s). For example, the deduplicated audience adjustment circuitry 206 uses selected values and the obtained audience total(s), impression total(s), and/or a priori information (if available) in the above equation 4, equations 7 and 8, or equation 10. In some examples, the deduplicated audience adjustment circuitry 206 may generate an output based on the relative chance between the audience total(s) (e.g.,

$$\frac{\vert {X}_{i} - {A}_{i} \vert}{{A}_{i}} )$$

and/or impression total(s) (e.g.,

$$\frac{\vert {T}_{i} - {R}_{i} \vert}{{R}_{i}} ) .$$

At block 314, the example comparator 208 determines if a threshold number of iterations have occurred. If the comparator 208 determines that a threshold number of iterations have not occurred (block 314: NO), control continues to block 318. If the comparator 208 determines that a threshold number of iterations have occurred (block 314: YES), the example comparator 208 determine if the difference between the output (e.g.,

$${\sum }_{i ∈ Ω} {( \frac{{X}_{i}}{{A}_{i}} - 1 )}^{2} )$$

for the current iteration and the output (e.g.,

$${\sum }_{i ∈ Ω} {( \frac{{X}_{i}}{{A}_{i}} - 1 )}^{2} )$$

for a previous iteration(s) is less than a threshold amount (block 316). As further described above, the example deduplicated audience adjustment circuitry 206 may select the value(s) for the modified deduplicated audience total(s) and/or impressions total(s) based on the results of one or more previous iterations to continue to minimize the output for each iteration. Accordingly, when the difference between outputs of subsequent iterations is below a threshold, the audience measurement entity circuitry 114 may determine that no more iterations are needed.

If the example comparator 208 determines that the difference between the output (e.g.,

$${\sum }_{i ∈ Ω} {( \frac{{X}_{i}}{{A}_{i}} - 1 )}^{2} )$$

for the current iteration and the output of the previous iteration(s) is not less than a threshold (block 318: NO), the example deduplicated audience adjustment circuitry 206 adjusts the value(s) of the modified audience total(s) and/or impression total(s) while still satisfying constraints based on the output of the current iteration (block 318) and control returns to block 312. If the example comparator 208 determines that the difference between the output for the current iteration and the output of the previous iteration(s) is less than a threshold (block 318: YES), the example reporting circuitry 210 selects the selected values of the modified audience total(s) and/or impression total(s) based on the iteration that resulted in the lowest output (e.g., the sum of the least square minimization or the minimum of the sum of squares corresponding to Equation 4). At block 322, the example reporting circuitry 210 generates a report based on value(s) for audience total(s) and/or impression total(s) (block 320) selected during the iteration that result in the lowest output. The report corresponds to modified deduplicated audience total(s) and/or impressions total(s) that are logically consistent and more accurate than the obtained inaccurate and logically inconsistent data. As described above, the reporting circuitry 210 may store, display/output, and/or transmit the report and/or the information included in the report.

FIG. 4 is a block diagram of an example processor platform 400 structured to execute the instructions 300 of FIG. 3 to implement the server 113 of FIG. 1 and/or the audience measurement entity circuitry 114 of FIG. 2. The processor platform 400 can be, for example, a server, a personal computer, a workstation, a self-learning machine (e.g., a neural network, an Internet appliance, or any other type of computing device.

The processor platform 400 of the illustrated example includes a processor 412. The processor 412 of the illustrated example is hardware. For example, the processor 412 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example server 113, the example interface circuitry 200, the example constraints determination circuitry 204, the example deduplication audience adjustment circuitry 206, the example comparator 208, and the example reporting circuitry 210 of FIG. 2.

The processor 412 of the illustrated example includes a local memory 413 (e.g., a cache). In the example of FIG. 4 the local memory 413 implements the example database(s) 202. However, the volatile memory 414 and/or non-violate memory 416 may implement the example database(s) 202. The processor 412 of the illustrated example is in communication with a main memory including a volatile memory 414 and a non-volatile memory 416 via a bus 418. The volatile memory 414 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 416 may be implemented by flash memory and/or any other desired type of memory device. Access to the main memory 414, 416 is controlled by a memory controller.

The processor platform 400 of the illustrated example also includes an interface circuit 420. The interface circuit 420 may be implemented by any type of interface standard, such as an Ethernet interface, a universal serial bus (USB), a Bluetooth® interface, a near field communication (NFC) interface, and/or a PCI express interface.

In the illustrated example, one or more input devices 422 are connected to the interface circuit 420. The input device(s) 422 permit(s) a user to enter data and/or commands into the processor 412. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 424 are also connected to the interface circuit 420 of the illustrated example. The output devices 424 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 420 of the illustrated example, thus, typically includes a graphics driver card, a graphics driver chip and/or a graphics driver processor.

The interface circuit 420 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 426. The communication can be via, for example, an Ethernet connection, a digital subscriber line (DSL) connection, a telephone line connection, a coaxial cable system, a satellite system, a line-of-site wireless system, a cellular telephone system, etc.

The processor platform 400 of the illustrated example also includes one or more mass storage devices 428 for storing software and/or data. Examples of such mass storage devices 428 include floppy disk drives, hard drive disks, compact disk drives, Blu-ray disk drives, redundant array of independent disks (RAID) systems, and digital versatile disk (DVD) drives.

Example machine executable instructions 432 represented in FIG. 3 may be stored in the mass storage device 428, in the volatile memory 414, in the non-volatile memory 416, and/or on a removable non-transitory computer readable storage medium such as a CD or DVD.

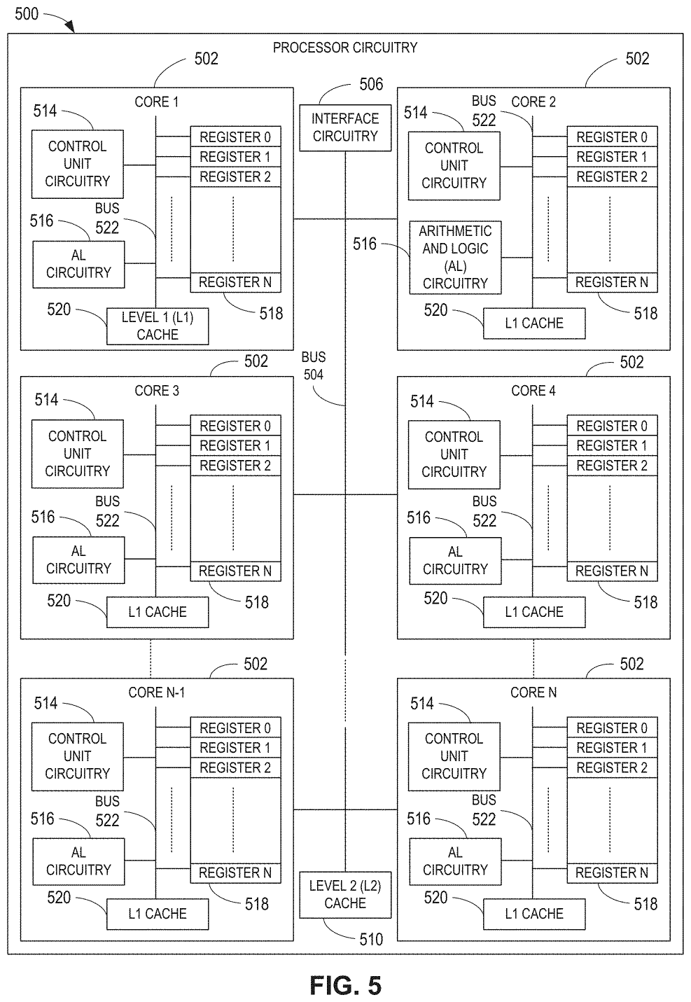

FIG. 5 is a block diagram of an example implementation of the processor circuitry 412 of FIG. 4. In this example, the processor circuitry 412 of FIG. 4 is implemented by a general purpose microprocessor 500. The general purpose microprocessor circuitry 500 executes some or all of the machine readable instructions of the flowchart of FIG. 3 to effectively instantiate the server 113 and/or audience measurement entity circuitry 114 of FIG. 2 as logic circuits to perform the operations corresponding to those machine readable instructions. In some such examples, the circuitry of FIG. 2 is instantiated by the hardware circuits of the microprocessor 500 in combination with the instructions. For example, the microprocessor 500 may implement multi-core hardware circuitry such as a CPU, a DSP, a GPU, an XPU, etc. Although it may include any number of example cores 502 (e.g., 1 core), the microprocessor 500 of this example is a multi-core semiconductor device including N cores. The cores 502 of the microprocessor 500 may operate independently or may cooperate to execute machine readable instructions. For example, machine code corresponding to a firmware program, an embedded software program, or a software program may be executed by one of the cores 502 or may be executed by multiple ones of the cores 502 at the same or different times. In some examples, the machine code corresponding to the firmware program, the embedded software program, or the software program is split into threads and executed in parallel by two or more of the cores 502. The software program may correspond to a portion or all of the machine readable instructions and/or operations represented by the flowchart of FIG. 3.

The cores 502 may communicate by a first example bus 504. In some examples, the first bus 504 may implement a communication bus to effectuate communication associated with one(s) of the cores 502. For example, the first bus 504 may implement at least one of an Inter-Integrated Circuit (I2C) bus, a Serial Peripheral Interface (SPI) bus, a PCI bus, or a PCIe bus. Additionally or alternatively, the first bus 504 may implement any other type of computing or electrical bus. The cores 502 may obtain data, instructions, and/or signals from one or more external devices by example interface circuitry 506. The cores 502 may output data, instructions, and/or signals to the one or more external devices by the interface circuitry 506. Although the cores 502 of this example include example local memory 520 (e.g., Level 1 (L1) cache that may be split into an L1 data cache and an L1 instruction cache), the microprocessor 500 also includes example shared memory 510 that may be shared by the cores (e.g., Level 2 (L2_ cache)) for high-speed access to data and/or instructions. Data and/or instructions may be transferred (e.g., shared) by writing to and/or reading from the shared memory 510. The local memory 520 of each of the cores 502 and the shared memory 510 may be part of a hierarchy of storage devices including multiple levels of cache memory and the main memory (e.g., the main memory 414, 416 of FIG. 4). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 502 may be referred to as a CPU, DSP, GPU, etc., or any other type of hardware circuitry. Each core 502 includes control unit circuitry 514, arithmetic and logic (AL) circuitry (sometimes referred to as an ALU) 516, a plurality of registers 518, the L1 cache 520, and a second example bus 522. Other structures may be present. For example, each core 502 may include vector unit circuitry, single instruction multiple data (SIMD) unit circuitry, load/store unit (LSU) circuitry, branch/jump unit circuitry, floating-point unit (FPU) circuitry, etc. The control unit circuitry 514 includes semiconductor-based circuits structured to control (e.g., coordinate) data movement within the corresponding core 502. The AL circuitry 516 includes semiconductor-based circuits structured to perform one or more mathematic and/or logic operations on the data within the corresponding core 502. The AL circuitry 516 of some examples performs integer based operations. In other examples, the AL circuitry 516 also performs floating point operations. In yet other examples, the AL circuitry 516 may include first AL circuitry that performs integer based operations and second AL circuitry that performs floating point operations. In some examples, the AL circuitry 516 may be referred to as an Arithmetic Logic Unit (ALU). The registers 518 are semiconductor-based structures to store data and/or instructions such as results of one or more of the operations performed by the AL circuitry 516 of the corresponding core 502. For example, the registers 518 may include vector register(s), SIMD register(s), general purpose register(s), flag register(s), segment register(s), machine specific register(s), instruction pointer register(s), control register(s), debug register(s), memory management register(s), machine check register(s), etc. The registers 518 may be arranged in a bank as shown in FIG. 5. Alternatively, the registers 518 may be organized in any other arrangement, format, or structure including distributed throughout the core 502 to shorten access time. The second bus 522 may implement at least one of an I2C bus, a SPI bus, a PCI bus, or a PCIe bus

Each core 502 and/or, more generally, the microprocessor 500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 500 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

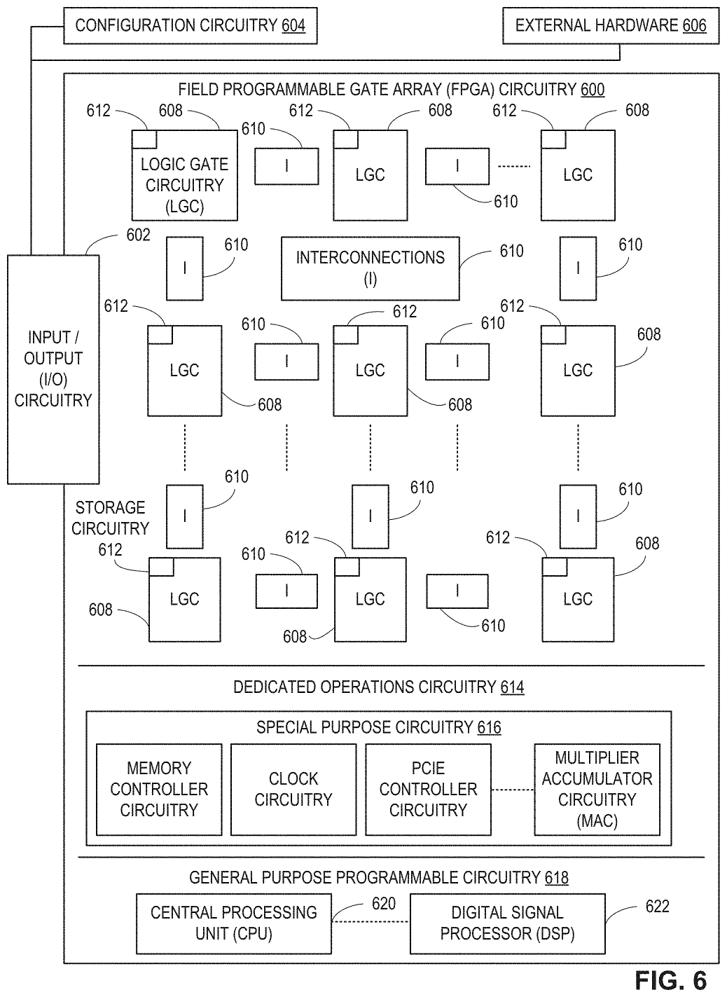

FIG. 6 is a block diagram of another example implementation of the processor circuitry 412 of FIG. 4. In this example, the processor circuitry 412 is implemented by FPGA circuitry 600. The FPGA circuitry 600 can be used, for example, to perform operations that could otherwise be performed by the example microprocessor 500 of FIG. 5 executing corresponding machine readable instructions. However, once configured, the FPGA circuitry 600 instantiates the machine readable instructions in hardware and, thus, can often execute the operations faster than they could be performed by a general purpose microprocessor executing the corresponding software.

More specifically, in contrast to the microprocessor 500 of FIG. 5 described above (which is a general purpose device that may be programmed to execute some or all of the machine readable instructions represented by the flowcharts of FIG. 3 but whose interconnections and logic circuitry are fixed once fabricated), the FPGA circuitry 600 of the example of FIG. 6 includes interconnections and logic circuitry that may be configured and/or interconnected in different ways after fabrication to instantiate, for example, some or all of the machine readable instructions represented by the flowcharts of FIG. 3. In particular, the FPGA 600 may be thought of as an array of logic gates, interconnections, and switches. The switches can be programmed to change how the logic gates are interconnected by the interconnections, effectively forming one or more dedicated logic circuits (unless and until the FPGA circuitry 600 is reprogrammed). The configured logic circuits enable the logic gates to cooperate in different ways to perform different operations on data received by input circuitry. Those operations may correspond to some or all of the software represented by the flowcharts of FIG. 3. As such, the FPGA circuitry 600 may be structured to effectively instantiate some or all of the machine readable instructions of the flowcharts of FIG. 3 as dedicated logic circuits to perform the operations corresponding to those software instructions in a dedicated manner analogous to an ASIC. Therefore, the FPGA circuitry 600 may perform the operations corresponding to the some or all of the machine readable instructions of FIG. 3 faster than the general purpose microprocessor can execute the same.

In the example of FIG. 6, the FPGA circuitry 600 is structured to be programmed (and/or reprogrammed one or more times) by an end user by a hardware description language (HDL) such as Verilog. The FPGA circuitry 600 of FIG. 6, includes example input/output (I/O) circuitry 602 to obtain and/or output data to/from example configuration circuitry 604 and/or external hardware (e.g., external hardware circuitry) 606. For example, the configuration circuitry 604 may implement interface circuitry that may obtain machine readable instructions to configure the FPGA circuitry 600, or portion(s) thereof. In some such examples, the configuration circuitry 604 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 606 may implement the microprocessor 500 of FIG. 5. The FPGA circuitry 600 also includes an array of example logic gate circuitry 608, a plurality of example configurable interconnections 610, and example storage circuitry 612. The logic gate circuitry 608 and interconnections 610 are configurable to instantiate one or more operations that may correspond to at least some of the machine readable instructions of FIG. 3 and/or other desired operations. The logic gate circuitry 608 shown in FIG. 6 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 608 to enable configuration of the electrical structures and/or the logic gates to form circuits to perform desired operations. The logic gate circuitry 608 may include other electrical structures such as look-up tables (LUTs), registers (e.g., flip-flops or latches), multiplexers, etc.

The interconnections 610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 608 to program desired logic circuits.

The storage circuitry 612 of the illustrated example is structured to store result(s) of the one or more of the operations performed by corresponding logic gates. The storage circuitry 612 may be implemented by registers or the like. In the illustrated example, the storage circuitry 612 is distributed amongst the logic gate circuitry 608 to facilitate access and increase execution speed.

The example FPGA circuitry 600 of FIG. 6 also includes example Dedicated Operations Circuitry 614. In this example, the Dedicated Operations Circuitry 614 includes special purpose circuitry 616 that may be invoked to implement commonly used functions to avoid the need to program those functions in the field. Examples of such special purpose circuitry 616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 600 may also include example general purpose programmable circuitry 618 such as an example CPU 620 and/or an example DSP 622. Other general purpose programmable circuitry 618 may additionally or alternatively be present such as a GPU, an XPU, etc., that can be programmed to perform other operations.

Although FIGS. 5 and 6 illustrate two example implementations of the processor circuitry 412 of FIG. 4, many other approaches are contemplated. For example, as mentioned above, modern FPGA circuitry may include an on-board CPU, such as one or more of the example CPU 620 of FIG. 6. Therefore, the processor circuitry 412 of FIG. 4 may additionally be implemented by combining the example microprocessor 500 of FIG. 5 and the example FPGA circuitry 600 of FIG. 6. In some such hybrid examples, a first portion of the machine readable instructions represented by the flowcharts of FIG. 3 may be executed by one or more of the cores 502 of FIG. 5, a second portion of the machine readable instructions represented by the flowcharts of FIG. 3 may be executed by the FPGA circuitry 600 of FIG. 6, and/or a third portion of the machine readable instructions represented by the flowcharts of FIG. 3 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 412 of FIG. 4 may be in one or more packages. For example, the processor circuitry 500 of FIG. 5 and/or the FPGA circuitry 600 of FIG. 6 may be in one or more packages. In some examples, an XPU may be implemented by the processor circuitry 412 of FIG. 4, which may be in one or more packages. For example, the XPU may include a CPU in one package, a DSP in another package, a GPU in yet another package, and an FPGA in still yet another package.

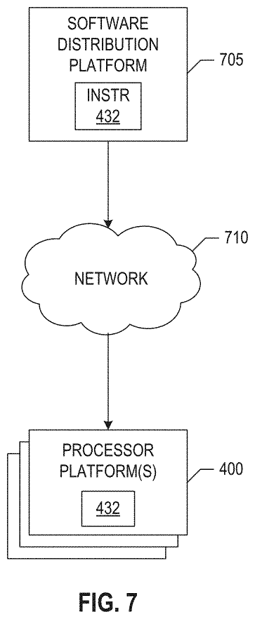

A block diagram illustrating an example software distribution platform 705 to distribute software such as the example machine readable instructions 432 of FIG. 4 to hardware devices owned and/or operated by third parties is illustrated in FIG. 7. The example software distribution platform 705 may be implemented by any computer server, data facility, cloud service, etc., capable of storing and transmitting software to other computing devices. The third parties may be customers of the entity owning and/or operating the software distribution platform 705. For example, the entity that owns and/or operates the software distribution platform 705 may be a developer, a seller, and/or a licensor of software such as the example machine readable instructions 432 of FIG. 7. The third parties may be consumers, users, retailers, OEMs, etc., who purchase and/or license the software for use and/or re-sale and/or sub-licensing. In the illustrated example, the software distribution platform 705 includes one or more servers and one or more storage devices. The storage devices store the machine readable instructions 432, which may correspond to the example machine readable instructions 300 of FIG. 3 as described above. The one or more servers of the example software distribution platform 705 are in communication with a network 710, which may correspond to any one or more of the Internet and/or any of the network. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 432 from the software distribution platform 705. For example, the software, which may correspond to the example machine readable instructions 300 of FIG. 3 may be downloaded to the example processor platform 400, which is to execute the machine readable instructions 432 to implement the example audience measurement entity circuitry 114. In some example, one or more servers of the software distribution platform 705 periodically offer, transmit, and/or force updates to the software (e.g., the example machine readable instructions 432 of FIG. 4) to ensure improvements, patches, updates, etc., are distributed and applied to the software at the end user devices.

Example methods, apparatus, systems, and articles of manufacture to modify audience estimates to preserve logical consistency are disclosed herein. Further examples and combinations thereof include the following: Example 1 includes an apparatus comprising at least one memory, instructions in the apparatus, and processor circuitry to execute the instructions to at least determine a set of initial audience totals includes at least one logical inconsistency, the initial audience totals including a first initial audience total associated with a first margin, a second initial audience total associated with a second margin, and a third initial audience total associated with a union of the first margin and the second margin, the initial audience totals being logically inconsistent based on a technique used to generate the initial audience totals, determine constraints based on a structure of the initial audience totals, for a number of iterations select values for modified audience totals that satisfy the constraints, the modified audience totals corresponding respectively to the initial audience totals, and determine an output based on the values for the modified audience totals and the initial audience totals, select final values of the modified audience totals resulting from completion of the number of iterations, the final values of the modified audience totals to be logically consistent, and generate a report including the final values of the modified audience totals.

Example 2 includes the apparatus of example 1, wherein the constraints include first constraints and second constraints, the processor circuitry to determine the first constraints based on the structure of the initial audience totals, and determine the second constraints to cause the modified audience totals to be within a threshold range of the initial audience totals.

Example 3 includes the apparatus of example 1, wherein the processor circuitry is to determine the output based on a relative change between the modified audience totals and the initial audience totals.

Example 4 includes the apparatus of example 1, wherein the processor circuitry is to determine the output based on a least squares difference between the modified audience totals and the initial audience totals.

Example 5 includes the apparatus of example 1, wherein the number of iterations is based on a threshold.

Example 6 includes the apparatus of example 1, wherein the processor circuitry is to determine when to stop the iterations based on a difference between the output of a current iteration to the output of a previous iteration.

Example 7 includes the apparatus of example 1, wherein the processor circuitry is to determine a set of initial impressions totals includes at least one logical inconsistency, the initial impressions totals including a first initial impressions total associated with the first margin, a second initial impressions total associated with the second margin, and a third initial impressions total associated with the union of the first margin and the second margin, the initial impressions totals being logically inconsistent based on a technique used to generate the initial impressions totals, for the number of iterations, select values for modified impressions totals that satisfy the constraints, the output further based on the values of the modified impressions totals, the modified impressions totals corresponding respectively to the initial impressions total, and select final values of the modified impressions totals resulting from completion of the number of iterations, the final values of the modified impressions totals to be logically consistent, the report including the final values of the modified impressions totals.

Example 8 includes a non-transitory computer readable medium comprising instructions which, when executed, cause one or more processors to at least determine a set of initial audience totals includes at least one logical inconsistency, the initial audience totals including a first initial audience total associated with a first margin, a second initial audience total associated with a second margin, and a third initial audience total associated with a union of the first margin and the second margin, the initial audience totals being logically inconsistent based on a technique used to generate the initial audience totals, determine constraints based on a structure of the initial audience totals, for a number of iterations select values for modified audience totals that satisfy the constraints, the modified audience totals corresponding respectively to the initial audience totals, and determine an output based on the values for the modified audience totals and the initial audience totals, select final values of the modified audience totals resulting from completion of the number of iterations, the final values of the modified audience totals to be logically consistent, and generate a report including the final values of the modified audience totals.

Example 9 includes the computer readable medium of example 8, wherein the constraints include first constraints and second constraints, the instructions to cause the one or more processors to determine the first constraints based on the structure of the initial audience totals, and determine the second constraints to cause the modified audience totals to be within a threshold range of the initial audience totals.

Example 10 includes the computer readable medium of example 8, wherein the instructions cause the one or more processors to determine the output based on a relative change between the modified audience totals and the initial audience totals.

Example 11 includes the computer readable medium of example 8, wherein the instructions cause the one or more processors to determine the output based on a least squares difference between the modified audience totals and the initial audience totals.

Example 12 includes the computer readable medium of example 8, wherein the number of iterations is based on a threshold.

Example 13 includes the computer readable medium of example 8, wherein the instructions cause the one or more processors to determine when to stop the iterations based on a difference between the output of a current iteration to the output of a previous iteration.

Example 14 includes the computer readable medium of example 8, wherein the instructions cause the one or more processors to determine a set of initial impressions totals includes at least one logical inconsistency, the initial impressions totals including a first initial impressions total associated with the first margin, a second initial impressions total associated with the second margin, and a third initial impressions total associated with the union of the first margin and the second margin, the initial impressions totals being logically inconsistent based on a technique used to generate the initial impressions totals, for the number of iterations, select values for modified impressions totals that satisfy the constraints, the output further based on the values of the modified impressions totals, the modified impressions totals corresponding respectively to the initial impressions total, and select final values of the modified impressions totals resulting from completion of the number of iterations, the final values of the modified impressions totals to be logically consistent, the report including the final values of the modified impressions totals.

Example 15 includes an apparatus comprising interface circuitry to access data from a database, the data stored across multiple registers of the database, and processor circuitry including one or more of at least one of a central processor unit, a graphics processor unit, or a digital signal processor, the at least one of the central processor unit, the graphics processor unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations, or Application Specific Integrated Circuitry (ASIC) including logic gate circuitry to perform one or more third operations, the processor circuitry to perform at least one of the first operations, the second operations, or the third operations to instantiate deduplication audience adjustment circuitry to determine a set of initial audience totals includes at least one logical inconsistency, the initial audience totals including a first initial audience total associated with a first margin, a second initial audience total associated with a second margin, and a third initial audience total associated with a union of the first margin and the second margin, the initial audience totals being logically inconsistent based on a technique used to generate the initial audience totals, constraint determination circuitry to determine constraints based on a structure of the initial audience totals, the deduplication audience adjustment circuitry to for a number of iterations select values for modified audience totals that satisfy the constraints, the modified audience totals corresponding respectively to the initial audience totals, and determine an output based on the values for the modified audience totals and the initial audience totals, and select final values of the modified audience totals resulting from completion of the number of iterations, the final values of the modified audience totals to be logically consistent, and a report generator circuitry to generate a report including the final values of the modified audience totals.

Example 16 includes the apparatus of example 15, wherein the constraints include first constraints and second constraints, the constraint determination circuitry to determine the first constraints based on the structure of the initial audience totals, and determine the second constraints to cause the modified audience totals to be within a threshold range of the initial audience totals.

Example 17 includes the apparatus of example 15, wherein the deduplication audience adjustment circuitry is to determine the output based on a relative change between the modified audience totals and the initial audience totals.

Example 18 includes the apparatus of example 15, wherein the deduplication audience adjustment circuitry is to determine the output based on a least squares difference between the modified audience totals and the initial audience totals.

Example 19 includes the apparatus of example 15, wherein the number of iterations is based on a threshold.

Example 20 includes the apparatus of example 15, wherein the deduplication audience adjustment circuitry is to determine when to stop the iterations based on a difference between the output of a current iteration to the output of a previous iteration.

From the foregoing, it will be appreciated that example systems, methods, apparatus, and articles of manufacture have been disclosed that modify audience estimates to preserve logical consistency. Inconsistencies in initial audience total estimations and/or impressions total estimation may be inherent as a result of the techniques utilized to determine the audience sizes. Accordingly, the initial audience totals and/or impressions counts generated by a server and/or other computing device is inaccurate. To correct the server and/or computing device-based error and avoid logical inconsistencies caused by techniques to estimate the initial audience sizes and/or impression totals, examples disclosed herein adjust datasets to ensure consistency and more accurate deduplicated audience totals and/or impression information. Example, methods, systems, apparatus, and articles of manufacture prevent errors in later analysis thereby preserving processing power consumption, processing cycle consumption, or the like had such modification not been made to correct for inconsistencies. Disclosed systems, methods, apparatus, and articles of manufacture improve the efficiency of using a computing device by making minimal change to data (e.g., by limiting the Xi values to be within a threshold range of Ai, as described above in conjunction with the Frechet inequalities), thereby preserving the quality of the collected data which is beneficial for accuracy. Further, other techniques for maintaining consistency assign a memory row for each entity (e.g., person) counted, which is memory intensive but maintains consistency. Conversely, examples disclosed herein do not maintain a row in memory for each entity counted but rather adjust initially collected data to maintain logical consistency. Accordingly, examples disclosed herein improve the efficiency of using a computing device by reducing memory consumption as compared to other examples. Disclosed systems, methods, apparatus, and articles of manufacture are accordingly directed to one or more improvement(s) in the operation of a machine such as a computer or other electronic and/or mechanical device.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus comprising:
at least one memory;
instructions in the apparatus; and
processor circuitry to execute the instructions to at least:
determine a set of initial audience totals includes at least one logical inconsistency, the initial audience totals including a first initial audience total associated with a first margin, a second initial audience total associated with a second margin, and a third initial audience total associated with a union of the first margin and the second margin, the initial audience totals being logically inconsistent based on a technique used to generate the initial audience totals;
determine constraints based on a structure of the initial audience totals;
for a number of iterations:
select values for modified audience totals that satisfy the constraints, the modified audience totals corresponding respectively to the initial audience totals; and
determine an output based on the values for the modified audience totals and the initial audience totals;
select final values of the modified audience totals resulting from completion of the number of iterations, the final values of the modified audience totals to be logically consistent; and
generate a report including the final values of the modified audience totals.

2. The apparatus of claim 1, wherein the constraints include first constraints and second constraints, the processor circuitry to:
determine the first constraints based on the structure of the initial audience totals; and
determine the second constraints to cause the modified audience totals to be within a threshold range of the initial audience totals.

3. The apparatus of claim 1, wherein the processor circuitry is to determine the output based on a relative change between the modified audience totals and the initial audience totals.

4. The apparatus of claim 1, wherein the processor circuitry is to determine the output based on a least squares difference between the modified audience totals and the initial audience totals.

5. The apparatus of claim 1, wherein the number of iterations is based on a threshold.

6. The apparatus of claim 1, wherein the processor circuitry is to determine when to stop the iterations based on a difference between the output of a current iteration to the output of a previous iteration.

7. The apparatus of claim 1, wherein the processor circuitry is to:
determine a set of initial impressions totals includes at least one logical inconsistency, the initial impressions totals including a first initial impressions total associated with the first margin, a second initial impressions total associated with the second margin, and a third initial impressions total associated with the union of the first margin and the second margin, the initial impressions totals being logically inconsistent based on a technique used to generate the initial impressions totals;
for the number of iterations, select values for modified impressions totals that satisfy the constraints, the output further based on the values of the modified impressions totals, the modified impressions totals corresponding respectively to the initial impressions total; and
select final values of the modified impressions totals resulting from completion of the number of iterations, the final values of the modified impressions totals to be logically consistent, the report including the final values of the modified impressions totals.

8. A non-transitory computer readable medium comprising instructions which, when executed, cause one or more processors to at least:
determine a set of initial audience totals includes at least one logical inconsistency, the initial audience totals including a first initial audience total associated with a first margin, a second initial audience total associated with a second margin, and a third initial audience total associated with a union of the first margin and the second margin, the initial audience totals being logically inconsistent based on a technique used to generate the initial audience totals;
determine constraints based on a structure of the initial audience totals;
for a number of iterations:
select values for modified audience totals that satisfy the constraints, the modified audience totals corresponding respectively to the initial audience totals; and
determine an output based on the values for the modified audience totals and the initial audience totals;
select final values of the modified audience totals resulting from completion of the number of iterations, the final values of the modified audience totals to be logically consistent; and
generate a report including the final values of the modified audience totals.

9. The computer readable medium of claim 8, wherein the constraints include first constraints and second constraints, the instructions to cause the one or more processors to:
determine the first constraints based on the structure of the initial audience totals; and
determine the second constraints to cause the modified audience totals to be within a threshold range of the initial audience totals.

10. The computer readable medium of claim 8, wherein the instructions cause the one or more processors to determine the output based on a relative change between the modified audience totals and the initial audience totals.

11. The computer readable medium of claim 8, wherein the instructions cause the one or more processors to determine the output based on a least squares difference between the modified audience totals and the initial audience totals.

12. The computer readable medium of claim 8, wherein the number of iterations is based on a threshold.

13. The computer readable medium of claim 8, wherein the instructions cause the one or more processors to determine when to stop the iterations based on a difference between the output of a current iteration to the output of a previous iteration.

14. The computer readable medium of claim 8, wherein the instructions cause the one or more processors to:
determine a set of initial impressions totals includes at least one logical inconsistency, the initial impressions totals including a first initial impressions total associated with the first margin, a second initial impressions total associated with the second margin, and a third initial impressions total associated with the union of the first margin and the second margin, the initial impressions totals being logically inconsistent based on a technique used to generate the initial impressions totals;
for the number of iterations, select values for modified impressions totals that satisfy the constraints, the output further based on the values of the modified impressions totals, the modified impressions totals corresponding respectively to the initial impressions total; and
select final values of the modified impressions totals resulting from completion of the number of iterations, the final values of the modified impressions totals to be logically consistent, the report including the final values of the modified impressions totals.

15. An apparatus comprising:
interface circuitry to access data from a database, the data stored across multiple registers of the database; and
processor circuitry including one or more of:
at least one of a central processor unit, a graphics processor unit, or a digital signal processor, the at least one of the central processor unit, the graphics processor unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus;
a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations; or
Application Specific Integrated Circuitry (ASIC) including logic gate circuitry to perform one or more third operations;
the processor circuitry to perform at least one of the first operations, the second operations, or the third operations to instantiate:
deduplication audience adjustment circuitry to determine a set of initial audience totals includes at least one logical inconsistency, the initial audience totals including a first initial audience total associated with a first margin, a second initial audience total associated with a second margin, and a third initial audience total associated with a union of the first margin and the second margin, the initial audience totals being logically inconsistent based on a technique used to generate the initial audience totals;
constraint determination circuitry to determine constraints based on a structure of the initial audience totals;
the deduplication audience adjustment circuitry to:
for a number of iterations:
select values for modified audience totals that satisfy the constraints, the modified audience totals corresponding respectively to the initial audience totals; and
determine an output based on the values for the modified audience totals and the initial audience totals; and
select final values of the modified audience totals resulting from completion of the number of iterations, the final values of the modified audience totals to be logically consistent; and
a report generator circuitry to generate a report including the final values of the modified audience totals.

16. The apparatus of claim 15, wherein the constraints include first constraints and second constraints, the constraint determination circuitry to:
determine the first constraints based on the structure of the initial audience totals; and
determine the second constraints to cause the modified audience totals to be within a threshold range of the initial audience totals.

17. The apparatus of claim 15, wherein the deduplication audience adjustment circuitry is to determine the output based on a relative change between the modified audience totals and the initial audience totals.

18. The apparatus of claim 15, wherein the deduplication audience adjustment circuitry is to determine the output based on a least squares difference between the modified audience totals and the initial audience totals.

19. The apparatus of claim 15, wherein the number of iterations is based on a threshold.

20. The apparatus of claim 15, wherein the deduplication audience adjustment circuitry is to determine when to stop the iterations based on a difference between the output of a current iteration to the output of a previous iteration.
